(19) United States
(12) Patent Application Publication
(10) Pub. No.: US 2002/0146157 A1
(43) Pub. Date: Oct. 10, 2002

(54) Fingerprint acquisition assembly using prism and camera

(76) Inventors: Mitchell E. Goodman, Coral Springs, FL (US); Troy D. Spain, Sunrise, FL (US); Charles B. Swope, Coral Springs, FL (US)

Correspondence Address: MOTOROLA, INC, INTELLECTUAL PROPERTY SECTION, LAW DEPT, 8000 WEST SUNRISE BLVD, FT LAUDERDAL, FL, 33322, US

(21) Appl. No.: 09/828,245

(22) Filed: Apr. 9, 2001

(51) Int. Cl. G06K 9/00

(52) U.S. Cl. 382/127

(57) ABSTRACT

A fingerprint acquisition assembly (110) includes a camera (205) for capturing an electronic image at a first focal range. An optical interface such as prism (207) or lens and mirror assembly (501,503) is used to provide a macro image to the camera (205) at a second focal range. The camera (205) is pivotable within the acquisition assembly (110) for capturing an image of a fingerprint in a second focal range though the prism (209) enabling the image to be easily transmitted to another location for authentication.

### TECHNICAL FIELD

This invention relates in general to imaging devices and more particularly to the dual function of image capture and fingerprint imaging devices.

### BACKGROUND

Presently there are many different types of devices that are used for capturing an image and sending the captured image to a computer or some type of wireless device. Cameras, scanners and other types of imaging devices come in various shapes sizes and are used for a variety of computer and wireless applications.

Moreover, the use of imaging today is applied in a variety of applications such as the transmission of documents, drawings and digital photography. One type of image that presently has many types of use is the fingerprint image. Although fingerprints are typically used for authentication of an individual's identity, these fingerprints are often difficult to obtain since they must be either “inked” and then copied or scanned. As seen in the prior art, this generally requires the used of bulky and expensive imaging equipment.

Typically, these types of imaging devices are often used with computer interface or wireless communication devices to authenticate a user's identity to gain access to a physical location or permit a user to operate some electronic device. Fingerprint authentication is becoming viable as a method of authorizing electronic commerce transactions. Also, digital photography is becoming a widespread application. Both of these functions are being integrated into communications devices. This makes it desirable to provide a device that can do both i.e. provide both photographic imaging in both a distant and macro mode while also providing the ability to scan fingerprints to be used to secure various types of authentication. These images can then be used with a computer or sent wirelessly in order to verify any subject's identity.

Accordingly, there is need to provide an electronic device that that can transmit electronic fingerprint images while also operating as a standard electronic camera.

### BRIEF DESCRIPTION OF THE DRAWINGS

FIG. 1 is a block diagram showing the fingerprint acquisition assembly according to one embodiment of the invention connected to an electronic two-way communications device.

FIG. 2 is an isometric view of the fingerprint acquisition assembly according to the preferred embodiment of the invention.

FIG. 3 is a side cross-sectional view of the fingerprint acquisition assembly as shown in FIG. 2 with the electronic camera pointing in an outward direction.

FIG. 4 is a side cross-sectional view of the fingerprint acquisition assembly as shown in FIG. 2 with the electronic camera pointing in an inward direction.

FIG. 5 is a side cross-sectional view of the fingerprint acquisition assembly as shown in FIG. 4 utilizing a lens and mirror.

### DETAILED DESCRIPTION OF THE PREFERRED EMBODIMENT

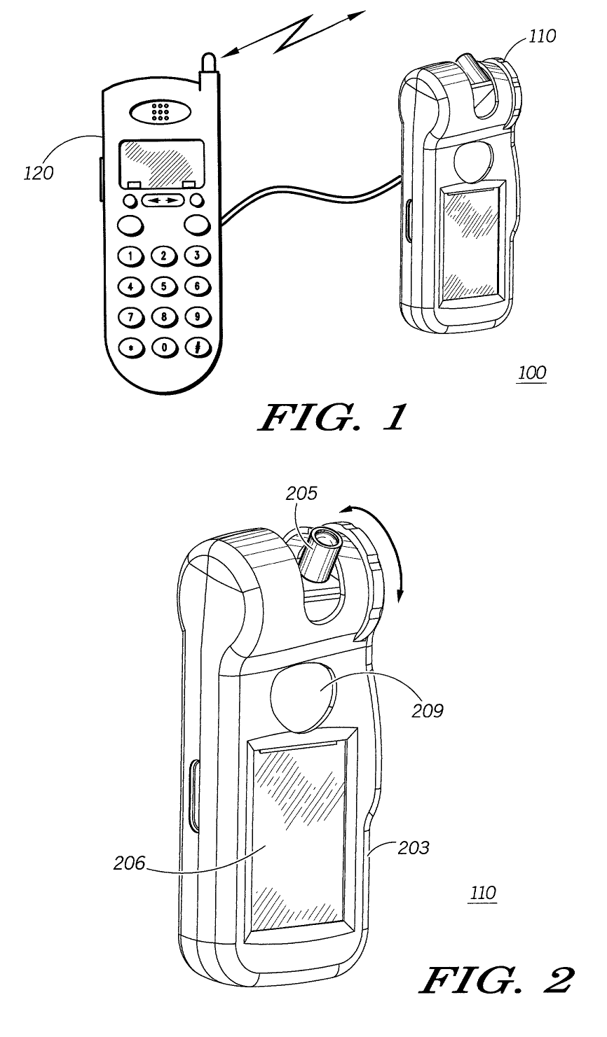

Referring now to FIG. 1, a fingerprint acquisition system 100 includes a fingerprint acquisition assembly 110. The fingerprint acquisition assembly 110 as discussed herein, is used to accurately capture an electronic image of a fingerprint, store the image and/or transmit the image using a portable communications device 120. As will be recognized by those skilled in the art, the fingerprint acquisition assembly can not only be used by law enforcement for a time efficient identification of an individual but it also to “secure” on-line purchases. When used in an e-commerce environment, the fingerprint acquisition system 100 can operate where both the business and customer can be assured that any transaction is authentic and without fraudulent intent.

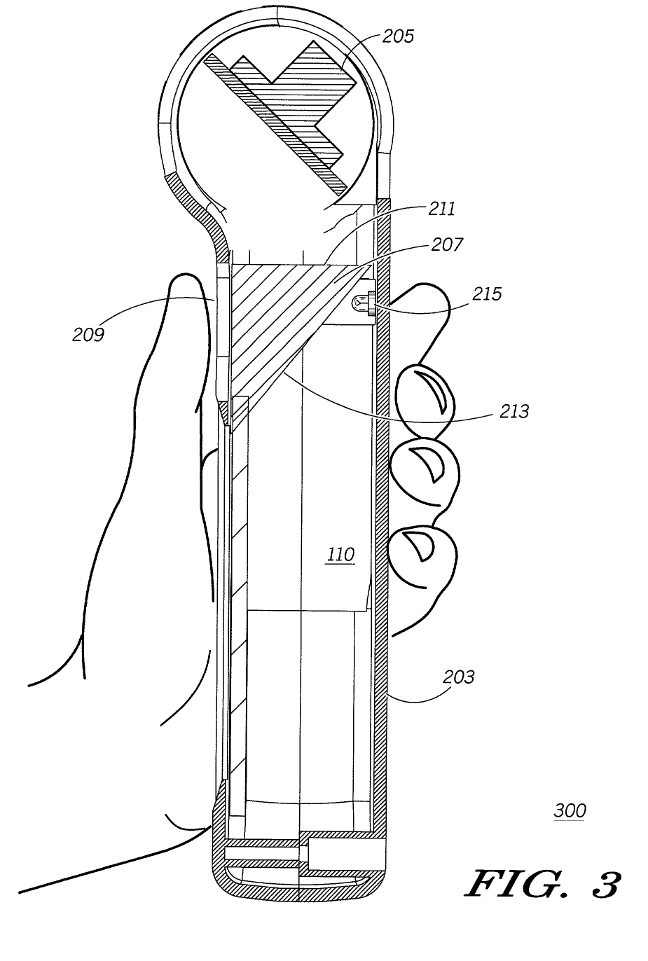

FIGS. 2 through 4 depict details of the fingerprint acquisition assembly 110. The acquisition assembly 110 includes a housing 203 where an electronic camera 205 is mounted at one end of the housing 203 and is pivotable therein. The camera 203 pivots in a wide range such that it can be pointed to suit the user. As seen in FIGS. 2 and 3, the camera 205 can be either directed so to provide electronic images in a first focal range or at a second focal range. In the first focal range the camera is typically point towards an object and operates like a standard electronic camera. This generally might be one foot distance to infinity. When the camera is pivoted to point inward or inside the device, the camera aperture is aimed at an optical interface assembly such as prism 207 or a lens and mirror arrangement.

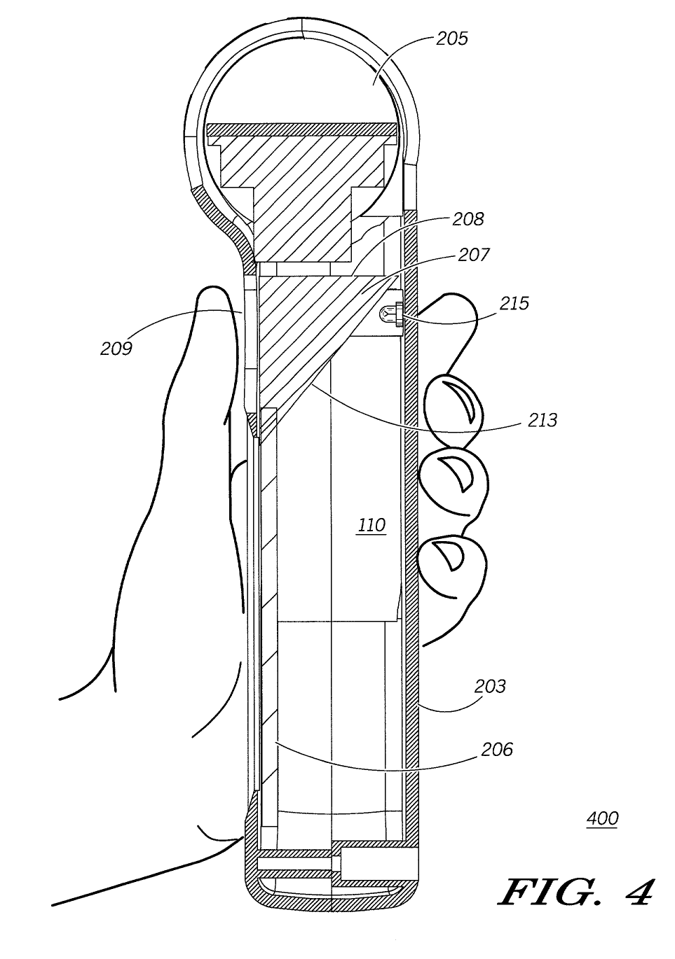

FIG. 3 shows a side-sectional view 300 of the fingerprint acquisition assembly 110 with the camera 205 point to capture an image in a first focal range. FIG. 4 also illustrates a side-sectional view 400 of the fingerprint acquisition assembly 110 with the camera 205 pointed in an inward direction to capture a fingerprint image in the second focal range. In either the first focal range or the second focal range, the image may be projected on an internal viewing screen 206. A skilled artisan will recognize that this may be either a cathode ray tube (CRT) device or an liquid crystal display (LCD) whose face is recessed into the housing 203 of the fingerprint acquisition assembly 110.

As is well known in the art, a prism 207 is a transparent body that is bound in part by two non-parallel plane faces and is used to refract or disperse a beam of light. The prism 207 includes a first prism surface 207, second prism surface 209 and a third prism surface 213. As seen in FIGS. 3 to 5, a user places a finger that inherently includes a ridged fingerprint or thumbprint onto the third prism surface 209, where an image of the fingerprint is refracted and focused on the second surface through the prism 207 where it is exits at the first surface 208. The camera 205, aimed downward towards the first surface 207, can capture the fingerprint image in the second focal range. The prism redirects the light and refocuses it to the focal range of the camera optics.

As will be recognized by those skilled in the art, the second focal range is generally between zero inches (at the surface of the second prism surface 209) to less than one inch in length. The image of a fingerprint will be quickly unfocused or skewed once the finger is raised from the second prism surface 209. Additionally, a backlight 215 may also be used to provide a light source through third prism surface 213 so as to allow the camera 205 to capture a clear and sharp electronic image of the fingerprint.

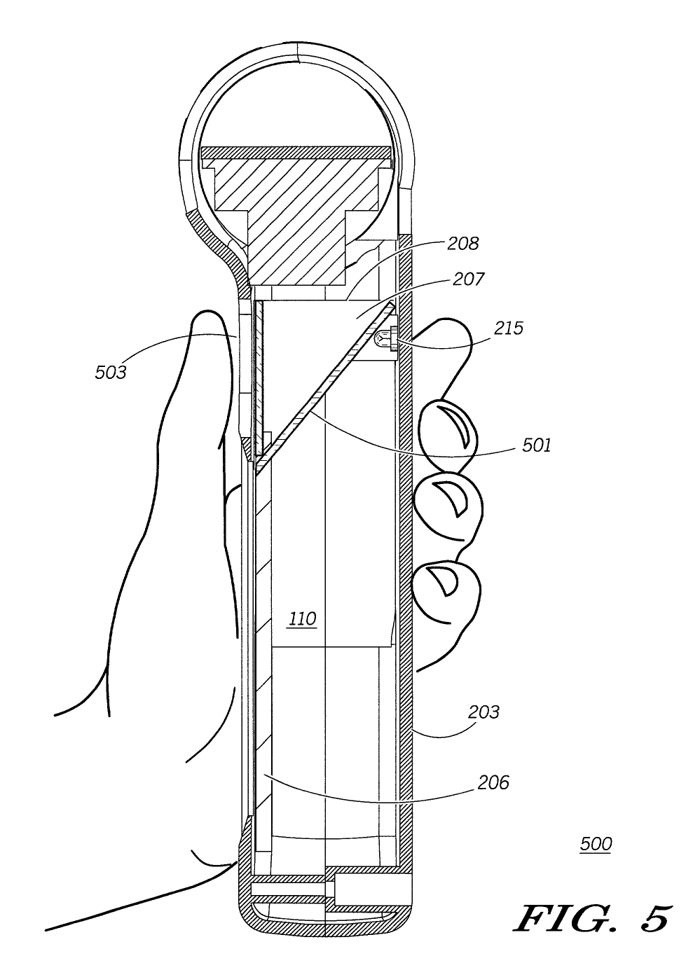

As seen in FIG. 5, an alternative embodiment shows a side-sectional view 500 of the fingerprint acquisition assembly 110 utilizing an optical interface assembly such as a reflecting mirror 501 and a clear lens 503. In this embodiment the user would place a finger on the clear lens 503 where it would be focused by the lens 503 and projected at a predetermined angle with the mirror 501 towards the camera 205.

Once the image is captured by the electronic camera 205, it can then be stored locally at the camera or sent direct to a stand alone or networked portable communications device as seen in FIG. 1. It will be recognized by those skilled in the art that the portable communications device can range from two-way radio, cellular telephone, personal digital assistant (PDA) or standard desktop or laptop computer system.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A fingerprint acquisition assembly comprising:
at least one camera for capturing an electronic image at a first focal range;
at least one optical interface for providing a macro image to the at least one camera at a second focal range; and
wherein the at least one camera pivots within the acquisition assembly for capturing a fingerprint image in the second focal range though the at least one optical interface.

2. A fingerprint acquisition assembly as in claim 1 wherein the optical interface is a prism.

3. A fingerprint acquisition assembly as in claim 1 wherein the optical interface is a mirror and lens assembly.

4. A fingerprint acquisition assembly as in claim 1, wherein the acquisition assembly can be connected to a two-way communications device for electronic transmission of the image to a remote location.

5. A fingerprint acquisition assembly as in claim 1, further wherein a finger is placed directly on a surface of the prism for acquisition by the at least one camera.

6. A fingerprint acquisition assembly as in claim 1, further comprising a display for viewing images generated by the at least one camera.

7. A fingerprint acquisition assembly for use in electronic fingerprint transmission comprising:
at least one digital camera for capturing an image in a first range of focal lengths;
at least one optical interface for providing a fingerprint image at a second range of focal lengths to the at least one camera; and
wherein the at least one camera is moveable with the acquisition assembly such that images maybe captured either in the first range of focal lengths or the second range of focal lengths.

8. A fingerprint acquisition assembly as in claim 7 where the at least one optical interface is a prism.

9. A fingerprint acquisition assembly as in claim 7 wherein the at least one optical interface is a lens and mirror assembly.

10. The fingerprint acquisition assembly as in claim 7, wherein the acquisition assembly can be connected to a two-way communications device for electronic transmission of the image to a remote location.

11. The fingerprint acquisition assembly as in claim 7, wherein the acquisition assembly provides connection to a networked device used for electronic exchange or storage of images and fingerprints.

12. The fingerprint acquisition assembly as in claim 7,
further wherein a finger is placed directly on a surface of the at least one prism for acquisition by the at least one camera.

13. The fingerprint acquisition assembly as in claim 7, further comprising a display for viewing images from the at least one digital camera.

14. A method of acquiring a fingerprint for electronic transmission over a communications device comprising the steps of:
providing at least one electronic camera for capturing an image in a first focal length range;
providing at least one optical interface for supplying a fingerprint image to the least one electronic camera in a second focal length range;
pivoting the camera within a camera assembly depending upon whether an image is desired from the first focal length range or the second focal length range; and
transmitting a captured fingerprint image using the communications device.
of acquiring a fingerprint for electronic transmission as in claim 10, further comprising the step of:
positioning a finger directly on a surface of the at least one prism to provide a fingerprint image in the second focal length range.

15. A method of acquiring a fingerprint for electronic transmission as in claim 14, wherein the optical interface is a prism.

16. A method of acquiring a fingerprint for electronic transmission as in claim 14, wherein the optical interface is a lens and mirror assembly.

17. A method of acquiring a fingerprint for electronic transmission as in claim 14, further comprising the step of:
displaying an image generated by the at least one electronic camera before electronic transmission over the communications device.
